(19) United States
(12) Patent Application Publication
(10) Pub. No.: US 2008/0261506 A1
(43) Pub. Date: Oct. 23, 2008

(54) SYSTEM AND METHOD FOR PAYOUT OF COINS FROM MULTIPLE COIN STORAGE UNITS

(76) Inventors: Joseph L. Levasseur, Chesterfield, MO (US); Michael A. Nogin, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/421,957

(22) Filed: Jun. 2, 2006

Related U.S. Application Data
(60) Provisional application No. 60/686,772, filed on Jun. 2, 2005.

(51) Int. Cl. G07D 1/00

(52) U.S. Cl. 453/57

(57) ABSTRACT

A device for the payout of coins includes a plurality of coin payout tubes, a plurality of coin discharge members, and an endless element having an engagement pin. Each coin payout tube has a coin discharge member located at one end of the coin payout tube. The coin discharge members are each physically adapted to rotate about a pivot point such that when the coin discharge members are rotated in a first direction the coin discharge members cause a coin to be ejected from its respective coin payout tube. When the coin discharge members are rotated in a second direction a coin is not discharged from its respective coin payout tube. The endless element and engagement pin are physically arranged to allow the engagement pin to rotate the coin discharge members in the first direction when the endless element is rotated in a first direction and to rotate the coin discharge members in the second direction when the endless element is rotated in a second direction.

### RELATED APPLICATIONS

The present invention claims priority to U.S. Provisional Patent Application Ser. No. 60/686,772 filed Jun. 2, 2005, the contents of which are incorporated herein by reference.

### BACKGROUND OF THE INVENTION

The invention relates to a change dispenser having multiple coin storage units for use in automatic point of sales transactions. Many methods of paying out change using multiple storage units (such as tubes) utilize a motor to dispense with one or more solenoids to select the particular coin tube. Another method widely employed is the use of three solenoids to dispense from three coin tubes. Still others use a motor that dispenses two different denominations depending upon the direction the motor is operated.

Another method employed is by using one motor to provide the selection of one of several coin tubes and then using a second motor to dispense the selected coin. A still further system utilized a solenoid to operate a stepper selector that selects a particular coin tube and then using a motor or solenoid to dispense the selected coin.

It would be advantageous to provide a coin payout method that would dispense from multiple coin storage units providing for the required number of denominations and with large capacity. It would also be advantageous to provide a coin payout method that would allow more than one denomination to be dispensed from a coin storage unit without any mechanical modification or adjustments. Another advantage would be to provide a method of coin dispensing from multiple coin storage units that would reduce costs and space by using only one actuator.

### SUMMARY OF THE INVENTION

The present invention provides a device for the payout of coins comprising a plurality of coin storage units, a plurality of coin discharge members, and an endless element having an engagement pin. Each coin storage unit has a coin discharge member located at one end of the coin storage unit. The coin discharge members are each physically adapted to rotate about a pivot point such that when the coin discharge members are rotated in a first direction the coin discharge members cause a coin to be ejected from its respective coin storage unit. When the coin discharge members are rotated in a second direction a coin is not discharged from its respective coin storage unit. The endless element and engagement pin are physically arranged to allow the engagement pin to rotate the coin discharge members in the first direction when the endless element is rotated in a first direction and to rotate the coin discharge members in the second direction when the endless element is rotated in a second direction.

### BRIEF DESCRIPTION OF THE DRAWINGS

FIG. 1 is a bottom perspective view of a coin payout device according to an embodiment of the present invention;

FIG. 2 is a bottom perspective view of a coin payout device according to an embodiment of the present invention illustrating coin discharge;

FIG. 3 is an enlarged perspective view of a coin discharge member according to an embodiment of the present invention;

FIG. 4 is a side view of the two rows of coin storage units according to an embodiment of the present invention;

FIG. 5 is a top perspective view of a coin discharge member according to an embodiment of the present invention;

FIG. 6 is a side view showing the relationship of a coin discharge member with a stack of coins to be discharged according to an embodiment of the present invention;

FIG. 7 is an enlarged perspective view of an optical coupler and drive sprocket according to an embodiment of the present invention;

FIG. 8 is a bottom view of a coin payout device with the optical coupler and drive sprocket situated at the bottom thereof according to an embodiment of the present invention; and

FIG. 9 is a drawing showing a typical spring arrangement for returning the coin discharge member to its first operating position according to an embodiment of the present invention.

### DETAILED DESCRIPTION OF THE PREFERRED EMBODIMENT

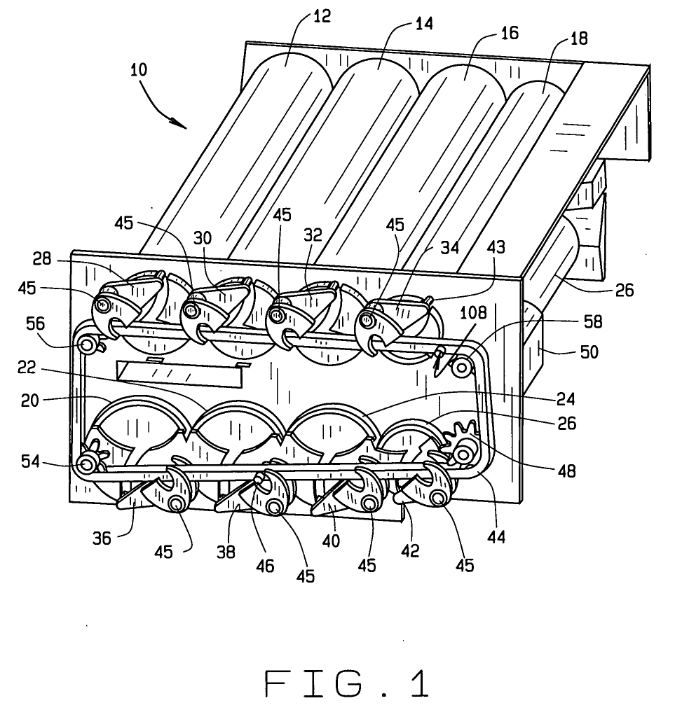

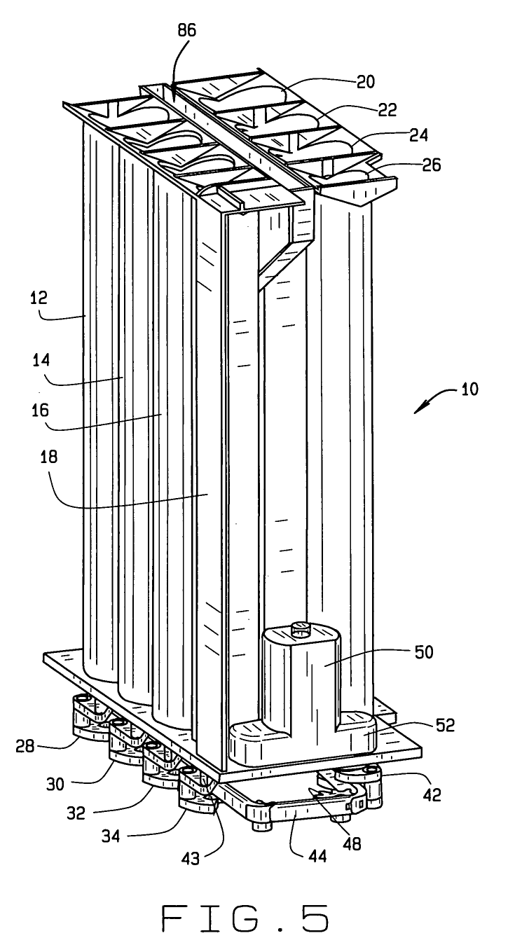

Referring now to the drawings, wherein like numerals refer to like items, number 10 identifies a preferred embodiment of a coin payout device having multiple storage units constructed according to the present invention. Referring now to FIG. 1, the coin payout device 10 is used to pay out coins from coin storage units 12, 14, 16, 18, 20, 22, 24 and 26. Corresponding coin discharging members 28, 30, 32, 34, 36, 38, 40 and 42 are activated by an engagement pin 46 attached to endless element 44. The coin discharge members 28 through 42 comprise bores mounted on dowels 45 that are attached to the coin payout device 10. When activated by the engagement pin 46 of endless element 44, the discharging member, for example 38, discharges the lowermost coin by rotating the coin discharge member 38 with a coin discharge member pin 43. For example, when the engagement pin 46 is moved to the right, it will rotate the coin discharge member 38 clockwise about dowel 45 thereby causing the coin discharge member pin 43 to push out the lowermost coin in the storage unit 22. A motor 50 turns drive sprocket 48 via a gearbox 52 (FIG. 5) to control the endless element 44. Idler sprockets 54, 56 and 58 are used to maintain the position and movement of the endless element 44.

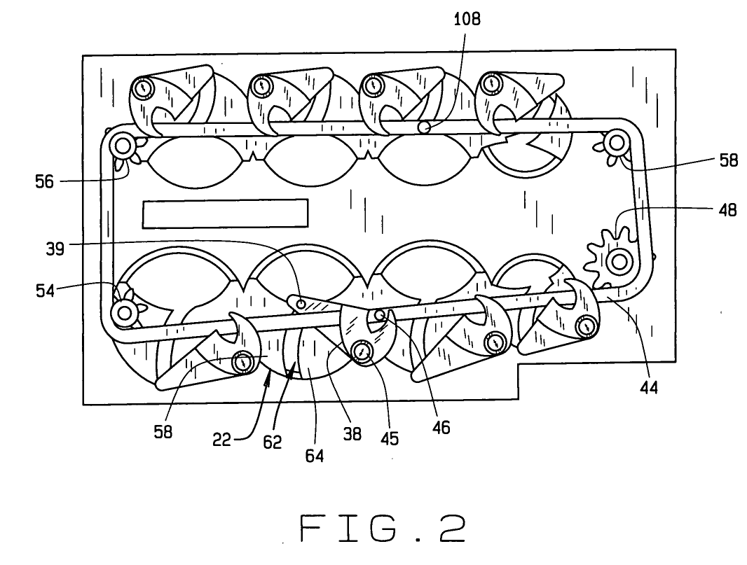

In FIG. 2 the coin discharge member 38 is shown in a discharge position after the engagement pin 46 has moved to the right and a coin has been discharged from the storage unit 22. At this point, because the coin discharge members 28 through 42 are located in the path of the engagement pin 46, the endless element 44 is moved from its resting position shown in FIG. 1 to the discharge position to discharge a coin with the coin discharge member pin 43. The coin discharge member 38 is moved back to its resting position of FIG. 1 by urging the coin discharge member 38 with the engagement pin 46. The coin discharge member 38 may also be biased back to its resting position by a spring, as described below. A curved slot 62 in the base 64 of coin storage unit 22 allows the discharge member pin 43 to drive out the bottom coin as it is rotated approximately 60 degrees.

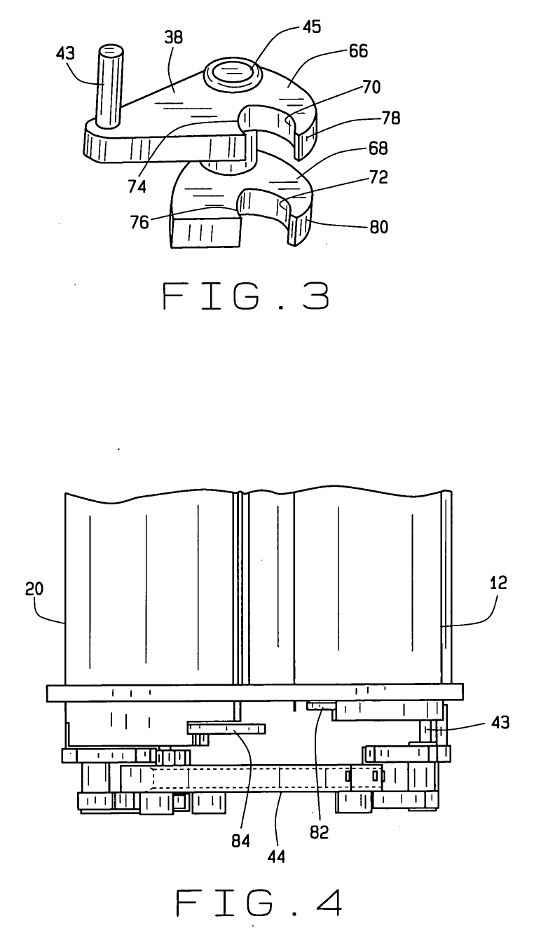

In FIG. 3 the coin discharge member 38 is shown in greater detail with the coin discharge member pin 43 attached thereto and the mounting dowel 45 that extends therethrough. Projections 66 and 68 extend to define surfaces 70 and 72 with a cavity that engages the engagement pin 46 of the endless element 44 to discharge a coin, as well as surfaces 74 and 76 to return the coin discharge member 38 to its resting position.

Because the coin discharge members 28 through 42 are located in the path of the engagement pin 46, for the engagement pin 46 to move past the coin discharge member 28 through 42 without dispensing a coin, the pin 46 must move clockwise with respect to FIG. 2 to not engage the surfaces 70 and 72 thereby ejecting a coin. In this manner, the pin 46 strikes the surfaces 78 and 80 (FIG. 3) of the coin discharging members 28 through 42 and causes the coin discharge member, for example coin discharge member 38, to move counterclockwise about its dowel 45 thereby pushing the discharge member pin 43 away from the opening of coin storage unit 22. As such, a coin is not ejected and the pin 46 may be moved to the appropriate coin storage unit 12 through 26 for the ejection of the appropriate coin.

FIG. 4 shows two coin storage units 12 and 20. The larger coin denomination storage unit 20 is shown in front of coin storage unit 12. It can be understood from FIG. 4 that coin storage units 12, 14, 16 and 18 comprising a first row of coin storage units eject coins from a higher position 82 than coin storage units 20, 22, 24 and 26 comprising a second row, which eject coins at a lower position 84. This prevents interference by coins with the opposite row of coin storage units during payout.

The perspective view of FIG. 5 shows the placement of the motor 50 and its gear box 52 with respect to the coin storage units 12 through 26, the endless element 44, drive sprocket 48, and the coin discharge members 28 through 42. An opening 86 is provided for coins that are accepted from a depositor that are not to be directed into storage units 12 through 26 for payback. The opening 86 extends through the device 10 such that the coins may be held in a coin hopper (not shown) that is located below the device 10. The motor 50 can be a DC motor that can operate clockwise and counterclockwise by reversing the applied voltage polarity, as is commonly known, or it can be a stepper motor that can rotate in either direction by the known methods of applying pulse trains to the coils thereof.

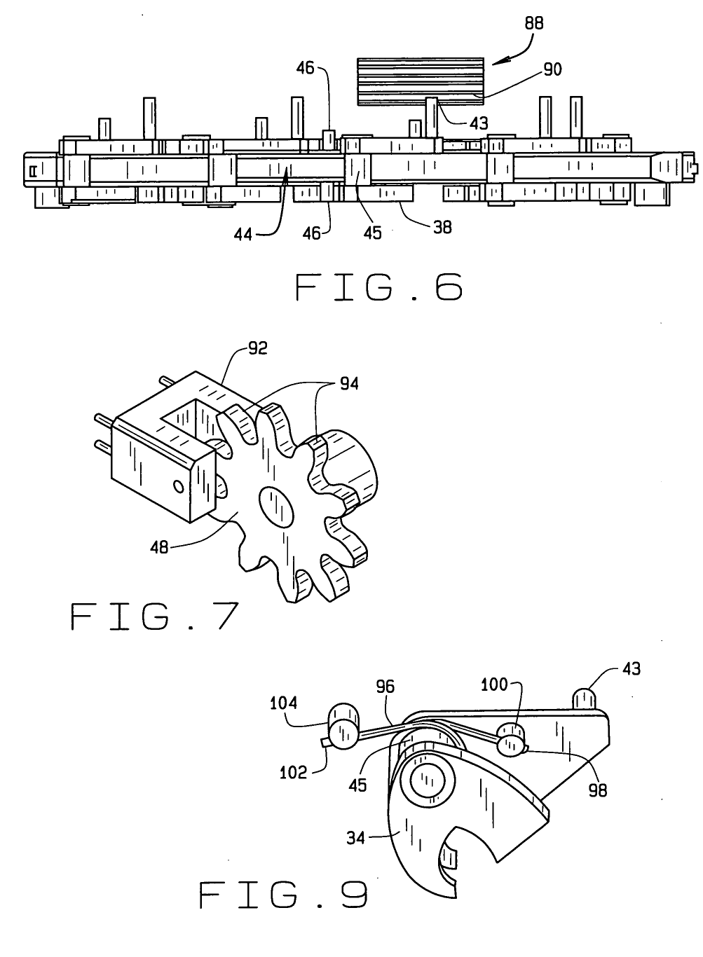

In FIG. 6, a side view of a stack of coins 88 is shown with its lowermost coin 90 being discharged by a pin 43 of the discharge member 38, which is being driven by the engagement pin 46 of the endless element 44. The height of the pin 43 is selected such that it comes to an elevation slightly lower than the top of the lowermost coin 90 such that when it moves to eject a coin, it only ejects a single coin.

If the motor 50 is selected to be a DC motor, an optical coupler 92 (FIG. 7) can be positioned to detect teeth 94 of the drive sprocket 48 as they interrupt its optic path thereof as the endless element 44 is driven. In this manner a processor controlling the device 10 can determine the position of the pin 46 in order to direct it to the desired coin storage unit 12 through 26. Other techniques are well known, such as using a shaft-encoded wheel in the motor drive system, a magnetically operated Hall Effect device, and other position determining methods.

If the motor is selected to be a stepper motor, an optical coupler is unnecessary, as a stepper motor is moved a precision rotation by a train of electrical pulses. Thus the location of the pin 46 is calculated by the number of pulses applied to the stepper motor.

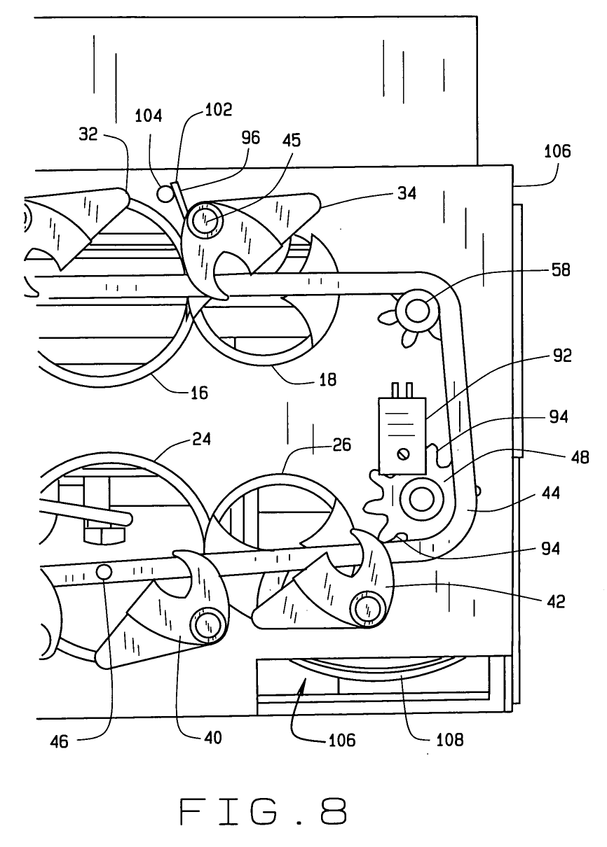

FIGS. 7 and 8 show the placement of the optical coupler 92 with respect to the drive sprocket 48 and the relationship to the endless element 44 and its engagement pin 46. In this illustration, each interruption of the optical path of the optical coupler 92 by sprocket teeth 94 will equal a movement of predetermined length of the endless element 44. Other embodiments utilizing timing belts, plastic or metal drive chains, cable chains, as well as 3-D belts are within the scope of the present invention.

Turning now to both FIGS. 8 and 9 a coin discharge member 34 having a sprocket 48 and a coin discharge member pin 43 is shown with a spring 96 placed around the sprocket 48 of the coin discharge member 34. A first end 98 of the spring 96 engages a first boss 100 and a second spring end 102 engages a second boss 104, which is attached to the base 106 of the coin payout device 10. A spring 92 may or may not be used in combination with engagement pin 46 to return the coin discharge members 28 through 42 to their resting positions.

Referring back to FIG. 2, a second engagement pin 108 is located across from the engagement pin 46 on the endless element 44 such that it is at a position that it will not engage coin discharge member 28 through 42 while the engagement pin 46 is contacting a coin discharge member 28 through 42. In this manner, the processor operating the device can use either pin 46 or 108 to discharge coins. This saves time in discharging coins by preventing the pin 46 from having to be rotated a full revolution of the endless member 44 to eject a coin from a coins storage unit 12 through 26. Depending on the space requirements for operation and placement of the coin storage units, additional engagement pins can be utilized.

It is contemplated that the identity of engagement pin 46 can be distinguished from engagement pin 108 by making one of the pins 46 or 108 magnetic and detecting the magnetic pin with a magnetic sensor. Determining the identity of the pin 46 and 108 allows for easier zero-positioning of the endless element 44 between payout cycles.

From all the foregoing it is to be understood that the use of this multiple coin storage payout method is not limited to a coin changer for use in a vending machine or in an attended or unattended point of sale location, but can be used in any application where coins are to be dispensed. It should also be understood that the number of coin storage units and the arrangement thereof could be varied according to space and other requirements.

We claim:

1. A device for the payout of coins comprising:
a plurality of coin storage units, each storage unit having a coin discharge member located at one end thereof, the coin discharge members each physically adapted to rotate about a pivot point such that when the coin discharge members are rotated in a first direction, the coin discharge members cause a coin to be ejected from its respective coin storage unit and when the coin discharge members are rotated in a second direction, a coin is not discharged from its respective coin storage unit; and
an endless element having at least one engagement pin, the endless element and engagement pin physically arranged to allow the engagement pin to rotate the coin discharge members in the first direction when the endless element is rotated in a first direction and to rotate the coin discharge members in the second direction when the endless element is rotated in a second direction.

2. The device of claim 1 further comprising a reversible motor for rotating the endless element.

3. The device of claim 1 wherein each coin discharge member further defines a bore mounted over a dowel associated with each coin storage unit.

4. The device of claim 3 wherein each coin discharge member further comprises a coin discharge member pin for discharging a coin from a respective coin storage unit, each coin discharge member pin associated with a coin discharge member slot of each coin storage unit.

5. The device of claim 4 wherein each coin discharge member further comprises a projection for engaging the engagement pin.

6. The device of claim 5 wherein each coin discharge member further comprises a pair of projections for engaging the engagement pin.

7. The device of claim 5 wherein the projection defines a surface within a cavity for engaging the engagement pin.

8. The device of claim 1 wherein each coin discharge member is biased to a predetermined position by a spring.

9. The device of claim 1 wherein the engagement pin comprises a plurality of engagement pins.

10. A method of dispensing coins comprising the steps of:
providing a plurality of coin storage units;
providing a plurality of coin discharge members each associated with a coin storage unit;
providing an endless element having an engagement pin;
rotating the endless element in a first direction to engage and rotate a coin discharge member in first direction to discharge a coin from a respective coin storage unit; and
rotating the endless element in a second direction to locate the engagement pin adjacent a coin discharge member of a desired coin storage unit.

11. A device for the payout of coins comprising:
a plurality of coin storage units, each storage unit having a coin discharge member located at one end thereof, the coin discharge members each physically adapted to rotate about a pivot point such that when the coin discharge members are rotated in a first direction the coin discharge members cause a coin to be ejected from its respective coin storage unit and when the coin discharge members are rotated in a second direction a coin is not discharged from its respective coin storage unit;
each coin discharge member further comprising a coin discharge member pin for discharging a coin from a respective coin storage unit, each coin discharge member pin associated with a coin discharge member slot of each coin storage unit; and
an endless element having at least one engagement pin, the endless element and engagement pin physically arranged to allow the engagement pin to rotate the coin discharge members in the first direction when the endless element is rotated in a first direction and to rotate the coin discharge members in the second direction when the endless element is rotated in a second direction.

12. The device of claim 11 further comprising a reversible motor for rotating the endless element.

13. The device of claim 11 wherein each coin discharge member further defines a bore mounted over a dowel associated with each coin storage unit.

14. The device of claim 11 wherein each coin discharge member further comprises a projection for engaging the engagement pin.

15. The device of claim 14 wherein each coin discharge member further comprises a pair of projections for engaging the engagement pin.

16. The device of claim 14 wherein the projection defines a surface within a cavity for engaging the engagement pin.

17. The device of claim 11 wherein each coin discharge member is biased to a predetermined position by a spring.
